(19) United States
(12) Patent Application Publication
(10) Pub. No.: US 2011/0212691 A1
(43) Pub. Date: Sep. 1, 2011

(54) Paddle-integrated wireless controller

(75) Inventors: Dainuri Rott, Palo Alto, CA (US); Miles Hopkins, Redwood City, CA (US)

(73) Assignee: WAVEDRIVE SYSTEMS, INC., Redwood City, CA (US)

(21) Appl. No.: 13/037,110

(22) Filed: Feb. 28, 2011

Related U.S. Application Data
(60) Provisional application No. 61/309,006, filed on Mar. 1, 2010.

(51) Int. Cl. H04B 7/00; B23P 11/00

(52) U.S. Cl. 455/41.3; 29/428

(57) ABSTRACT

Wireless transmitters are integrated with manual marine-propulsion implements associated with small watercraft (paddles, oars, poles, and the like). The transmitters are controlled by hand-operated actuators. The actuators are designed to be manipulated without looking and positioned within convenient reach of an operator's normal hand position on the implement. A corresponding wireless receiver on a target device enables the transmitter signal to control the device. Thus, an operator of a small watercraft can control a useful target device without first shipping or otherwise securing the manual implement, and may simultaneously continue to manually propel or steer the watercraft with the implement. Application examples include a propulsion-assist motor on a stand-up paddled (SUP) surfboard.

### RELATED APPLICATIONS

This application claims priority to Provisional Pat. App. No. U.S. 61/309,006, filed 1 Mar. 2010. Other related applications include U.S. Ser. No. 13/026,317, concurrently filed as PCT/US11/24700 on 14 Feb. 2011; provisional U.S. 61/147,733 filed 27 Jan. 2009; and provisional U.S. 61/304,405 filed 13 Feb. 2010. All related applications are incorporated by reference.

### FEDERALLY SPONSORED RESEARCH AND DEVELOPMENT

None

### APPENDICES

None

### BACKGROUND

Related fields include short-range wireless communication, small watercraft traditionally propelled by manual implements (paddles, oars, poles, and the like), and particularly wireless control of a function of the watercraft by an operator using or holding such an implement.

Where navigable water is accessible, small manually-propelled watercraft tend to be useful and popular, either by themselves or as accessories to larger craft (tenders, lifeboats, dinghies, and the like). They are much less expensive to build and maintain than larger craft, and can travel in shallow waters and narrow passages where larger craft cannot. Their uses include fishing and other aquatic harvesting such as pearl-diving and mollusk-gathering; ferrying passengers; carrying messages and market goods (in “floating markets” the watercraft itself becomes the market stall); repairing or maintaining docks, buoys, and larger ships; and, increasingly in many locations, recreation and tourism.

Motors, navigation and communication equipment, and other useful devices developed for dry land and larger vessels were once impractical for small watercraft because the devices or their fuel supplies were too large, heavy, awkward, or hazardous. Advances in device miniaturization and efficient lightweight power supplies have now mitigated those disadvantages in many cases. For example, a stand-up-paddle (SUP) derivative of a simple surfboard can be equipped with a lightweight electric motor to assist propulsion as and when the operator desires, a global-positioning system (GPS) can fit in the pocket of a pack or jacket, and an LED spotlight for rescue, salvage, or wildlife observation is lightweight, energy-efficient, and produces relatively little unwanted heat. Many modern navigation and measurement devices can provide audible signals, including fairly complex synthesized speech, so the operator can make use of a device without looking at it.

Besides onboard devices, some nearby, associated, but offboard systems would benefit from being operable remotely, but at fairly close range, by operators of small watercraft. For example, “mother” ships and small docks could save energy by leaving only the minimum necessary beacon lights burning through the night if arriving small-watercraft operators could remotely and temporarily turn on extra lights while coming in to tie up.

A practical obstacle remains, though: To control these devices, an operator using a manual implement such as an oar, paddle, or pole to propel or steer a watercraft must first “ship oars” or otherwise secure the implement before turning attention to the target device. This can require some care if there are other people, fragile goods, or potentially entangling nets and poles on board, or if the water is choppy. Under some conditions, such as strong currents, shallow shoals, or tight spaces, pausing the use of the implement or diverting the operator's attention may be dangerous. For a very minimal structure such as an SUP board, there may not even be anywhere secure to ship the paddle.

Some wireless controllers or remotes are commercially available for certain marine outboard motors. These devices are typically designed to be hand-held, wrist-worn, or mounted on the watercraft hull or deck. To Applicant's knowledge as of this writing, no wireless device controller integrated into a manual propulsion implement, such as an oar, paddle, or pole, is available commercially.

Few patents address this specific field. U.S. Pat. No. 7,303,452 by Ertz et al. (“Kayak Paddle with Safety Light”), filed 4 Apr. 2005, describes paddle-mounted wireless control of LED safety lights. However, the lights are also mounted on the paddle, and the wireless control is taught simply as a possible alternative for cases where a wired connection from an LED-control circuit on the paddle to LED lights elsewhere on the paddle might be too difficult to route (e.g., through the interior of the paddle) or effectively waterproof. Nothing in Ertz teaches or suggests an on-paddle wireless controller to control devices external to the paddle.

Given the growing popularity of paddle sports such as kayaking and stand-up paddle surfing, as well as the enormous variety of traditional manually-propelled small watercraft (canoes, gondolas, pirogues, outriggers, dories, coracles, etc.), the persistent absence of such paddle-integrated wireless control devices in the market or in the patent literature indicates that this is a somewhat long-felt but unaddressed need.

A means of controlling an on-board target device (propulsion-assist motor, depth finder, global positioning system, two-way radio or satellite phone, etc.) with an actuator integrated with a manual-propulsion implement (e.g. paddle) and operable during normal use of the implement would therefore be useful to operators of small watercraft. The ability to use a target device without interrupting propulsion or steering can enhance the safety, efficiency, or pleasure of the journey. At a minimum, the ability to turn a battery-powered device on when needed and off when not needed would prolong the life of the battery; small watercraft are often used in non-urban areas where batteries and chargers may be scarce, and electric motors' power consumption is proportional to the cube of the velocity.

In addition, because many types of oars and paddles have asymmetrical blade profiles and blade angles, their use may require operators to switch hand positions, sometimes quite frequently; for instance, the hand on the grip and the hand on the shaft may need to trade places when moving the paddle from the port to the starboard side of the watercraft or vice versa. Therefore, operability with either hand is a desirable feature for a paddle- or pole-mounted actuator.

### SUMMARY

A wireless transmitter controlled by a hand-operable actuator is mounted on or integrated into a manual marine-propulsion implement (“MMPI”) such as a paddle, oar, or pole. The actuator design and position on the implement allows an operator to control an electronically-responsive function of the watercraft while continuing to hold or use the MMPI. The wireless transmitter sends control signals to at least one wireless receiver aboard or near the watercraft. Each wireless receiver provides input to a controller for at least one function, such as (but not limited to) auxiliary motor propulsion, two-way radio, global positioning and navigation.

Alternate configurations of actuators and transmitters render the improvement compatible with different types of MMPI (non-limiting examples include oars, steering oars, sweeps, sculls, single- and double-bladed paddles, poles and stand-up paddles). Various ways of adding a transmitter and actuator to an MMPI adapt the improvement to diverse market conditions.

The transmitter's power supply is lightweight, long-lasting, and replaceable or rechargeable. The transmitter, actuator, power supply, receiver, controller, and any hard-wired connections are sheathed, coated, potted, or sealed as necessary to protect them from damage by exposure to fresh water and salt water as well as the typical mechanical shocks, abrasions, temperature cycling, and solar ultraviolet exposure expected during operation, transportation, and storage of the associated watercraft. Finally, it is a further object to provide various alternative means for mounting or otherwise integrating the paddle-integrated wireless controller with watercraft paddles and oars, in order to accommodate various different types of watercraft paddles and oars (for example, stand-up paddle surfing paddles, double-bladed surf-kayak paddles, rowboat oars, lifeboat oars, Venetian gondola sculling oars, etc.).

### BRIEF DESCRIPTION OF THE DRAWINGS

FIG. 1A illustrates one embodiment of a wireless transmitter and its actuator mounted on a single-bladed paddle having a handgrip on the end opposite the blade

FIG. 1B is a cutaway view of transmitter housing 106, showing components inside.

FIG. 2 is a schematic block diagram of an alternate embodiment of the system electronics.

FIG. 3A illustrates a preferred embodiment for mounting an actuator and transmitter on an existing paddle.

FIG. 3B illustrates a simple embodiment of a shaft-mounting clip.

FIG. 4 illustrates a preferred embodiment for a paddle or pole with a forked or T-shaped grip.

FIGS. 5A, 5B, and 5C are examples of paddle shafts, oar handles, or pole sections with built-in multi-position selector switches as actuators.

FIG. 6 illustrates a removable shaft section that protects the electronics as in a built-in embodiment, yet is made to be interchangeable between different compatible MMPIs.

FIG. 7 illustrates an application example in stand-up paddle (SUP) surfing.

### DETAILED DESCRIPTION

A simple preferred embodiment includes a wireless transmitter and a suitable power supply (for example, one or more compact lightweight batteries such as “coin” or “button” cells) encapsulated in a waterproof transmitter housing and connected to respond to a waterproof “on/off” actuator. Both case and actuator are mounted on the shaft of a paddle near the grip. The actuator is positioned a few centimeters from an operator's normal hand position while paddling; easy to reach while continuing to use the paddle, but unlikely to be hit or grasped unintentionally. A receiver corresponding with the transmitter controls a propulsion-assist system (e.g., an electric motor). The operator starts the propulsion-assist by pushing or squeezing the actuator with part of the hand grasping the paddle grip. Releasing the switch returns it to its default position and causes the propulsion system to deactivate; this is a safety precaution in case the operator drops the paddle or some other disruption occurs.

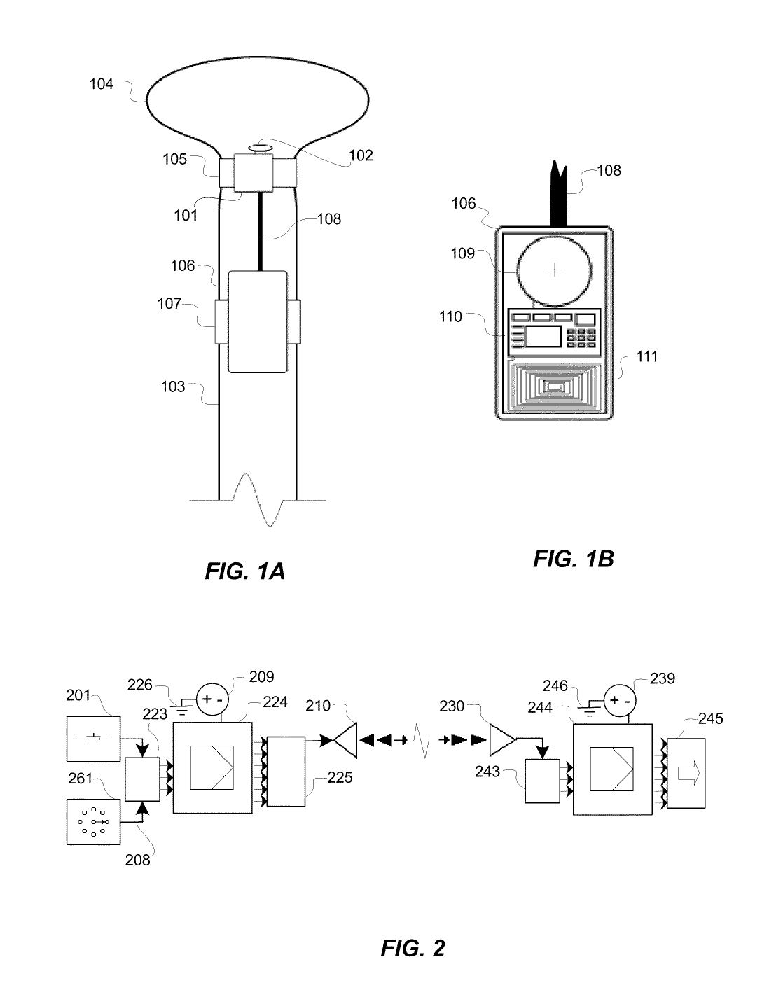

FIG. 1A illustrates one embodiment of a wireless transmitter and its actuator mounted on a single-bladed paddle having a handgrip on the end opposite the blade. Variants of this type of paddle are used on SUP surfboards and canoes, among others. Waterproof trigger unit 101 (made of waterproof ABS plastic or other suitable waterproof plastic, metal, or composite material) incorporating an actuator 102, is securely mounted on paddle shaft 103 adjacent to paddle grip 104.

In a typical paddling position, the knuckles of one of the operator's hands rest atop grip 104 with the fingers curling over and downward, while the other hand grasps shaft 103. Here, actuator 102 is shown for clarity as a spring-loaded button mounted to be depressed and released along an axis parallel to shaft 103, but other switch types such as Hall-effect sensors with magnets are also contemplated. Depending on the grip length, the operator's fingertips will either rest above or below actuator 102 while paddling. A small hand movement is necessary to bring the fingertip(s) into position to depress actuator 102, so that it is unlikely to be done by accident; yet the movement is small enough that it need not interrupt the paddling rhythm. Another advantage of this design is that paddles are most often bumped from the blade-tip end or from the side during use, transport, or storage. Therefore, the illustrated position and orientation of actuator 102 reduces the risk of damage by typical bumping.

Transmitter housing 106 (made of waterproof ABS plastic or other suitable material), is also securely mounted on shaft 103. Electrical leads 108 connect transmitter housing 106 to trigger unit 101.

Trigger unit 101 and transmitter housing 106 are secured to shaft 103 by any suitable couplings 105 and 107 respectively. Trigger-unit coupling 105 may comprise, for example, an adjustable metal hose clamp, a metal or plastic spring clip, an elastic band, a flexible band with an adjustable buckle or latch, or an open-ended fabric band with patches of hook-and-loop fastening material (e.g. Velcro™) positioned to facilitate band length adjustment for secure attachment to shaft 103. If trigger-unit coupling 105 can be temporarily loosened and slid along or rotated around shaft 103, or can be removed and replaced, trigger unit 101 can be optimally positioned for different operators, or the same operator who switches hand positions. Transmitter-housing coupling 107 may also benefit from being made adjustable if, for example, it must face substantially toward a receiver even when operators switch hands or seats. Couplings 105 and 107 may be attached to trigger unit 101 and transmitter housing 106 by any suitable method, including adhesives, rivets, and threading through holes or loops on the backs or sides of trigger unit 101 and transmitter housing 106. Inexpensive plastic tie-wraps or other commercially available cable-securing clamps or straps may serve as couplings 107 or 105, either by design or as emergency repairs.

FIG. 1B shows components inside transmitter housing 106. Compact electric power source 109 (illustrated here as a “coin cell” or “button cell,” though other power sources can also be used) delivers power to wireless transmitter 110, which is in turn connected to antenna 111 (in this embodiment, a printed PCB antenna). Electrical leads 108 penetrate transmitter housing 106 at a sealed and waterproof penetration, operably connecting trigger unit 101 (see FIG. 1A) to wireless transmitter 110. As an example, electric power source 109, wireless transmitter 110, and antenna 111 may be similar to those in commercial automobile keyless-entry “fobs”. However, while some automobile fobs may delay transmission of a signal for as much as ½ second after a switch is activated, the reaction time of some of these MMPI-mounted controllers (e.g. for a propulsion-assist motor in a balance-critical watercraft used in rough waters) is preferably much shorter. In other embodiments, if shaft 103 is electrically conductive (for example, the aluminum shafts in economically priced kayak paddles), it may be electrically connected with wireless transmitter 110 such that shaft 103 itself functions as antenna 111. Alternatively, a linear antenna may be deployed along the length of paddle shaft 103, either attached to its outer surface or recessed in, or fished through, an exterior or interior channel.

FIG. 2 is a schematic block diagram of an alternate embodiment of the system electronics. In this embodiment, the trigger unit(s) may include multiple actuators, illustrated by non-limiting example here as an “on/off” switch 201 and a multi-position selector switch 261. When an operator manipulates actuators 201 and 261, the resulting signals go through electrical leads 208 to input block 223 of transmitter controller 224. Transmitter controller 224 recognizes the incoming actuator signals and sends corresponding commands through output block 225 to control wireless transmitter 210 (which may be infrared as illustrated here, radio-frequency as in FIG. 1B, ultrasonic, or any other wireless technique compatible with the application). Power is supplied by power source 209 and the circuit is protected by ground connection 226.

In some embodiments, transmitter controller 224 includes a microprocessor with an information-storage element. The microprocessor's retrieval and execution of instructions programmed into the storage element enables the controller to interpret combinations of actuator manipulations (e.g. double-click, click and hold, select a setting and click) and generate a corresponding variety of commands resulting in a corresponding variety of distinguishable signals from transmitter 210.

Some applications benefit from a tactile feedback from actuators 201 and 261, such as a click or a persistent shape change, when the actuator is sufficiently engaged to change the signal of the wireless transmitter. With tactile feedback, the operator need not look down at the actuator or hear an audible alert such as a beep. This advantage is highly desirable in noisy and highly dynamic environments, such as rapids or surf.

Preferably, the transmitter does not interfere with other signal traffic, including similar wireless controllers for nearby watercraft. Limiting the transmitter's range, keying its frequency to its own receiver, and complying with local frequency-allocation standards (e.g., approved remote-control protocols for vehicle and building doors) all help to achieve this.

The signal from transmitter 210 is received by corresponding wireless receiver 230 on a target device. There may be more than one target device and associated receiver. Receiver 230 sends its signals through input block 243 of target-device controller 244. Target-device controller 244 translates the incoming receiver signal(s) into commands sent out through output block 245 to control the target device.

Target-device controller 244 may also have an associated microprocessor and storage element with stored instructions. For example, suppose the target device is a propulsion-assist motor and the watercraft is sensitive to balance. A very sudden cutoff of the motor may destabilize the craft or its operator. Therefore, the target-device microprocessor may retrieve an execute a “gradual stop” routine that ramps down the motor power gradually. This can be critically important for safety and control especially in surf or whitewater.

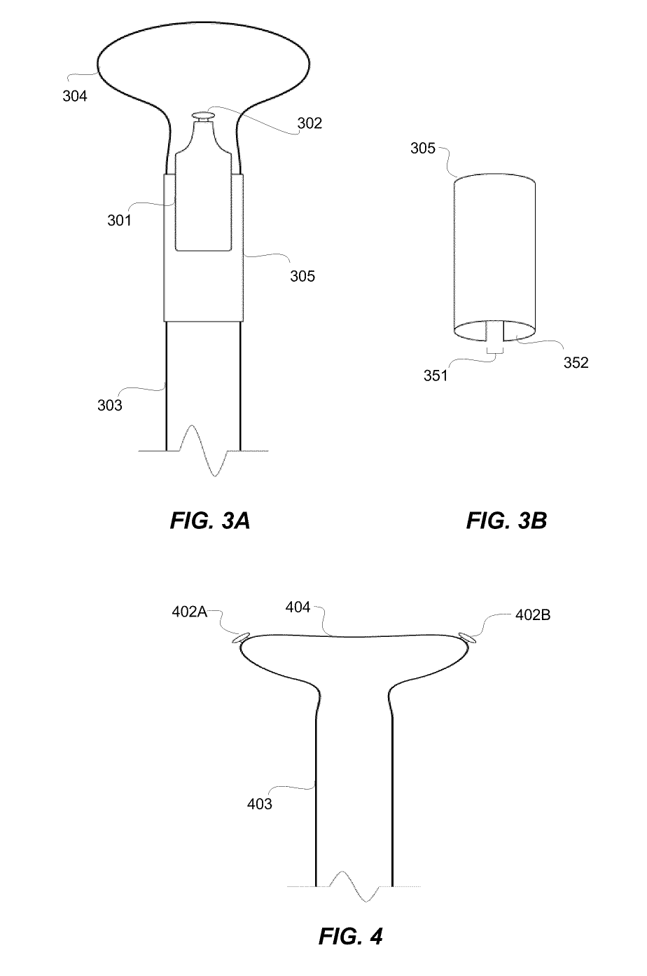

FIG. 3A illustrates a preferred embodiment for mounting an actuator and transmitter on an existing paddle. In some environments, such as river rapids, paddles often break. This embodiment enables an intact actuator/transmitter to be easily transferred from a damaged paddle to an undamaged one. Here, ruggedized waterproof transmitter housing 301 contains the trigger unit as well as the transmitter, its power source, and any antenna, speaker, or optics needed for broadcast of the transmitter signal. Actuator 302 is mounted directly on housing 301, eliminating the need for external, potentially vulnerable electrical leads 108 (see FIGS. 1A, 1B). In this example, transmitter housing 301 is integrated with or attached to shaft-mounting clip 305, which can be attached to or released from paddle shaft 303. Shaft-mounting clip 305 is installed on shaft 103 to position actuator 302 optimally for operation by one or more of user's fingers gripping paddle grip 104.

FIG. 3B illustrates a simple embodiment of shaft-mounting clip 305: a partial cylinder of “springy” plastic, metal, or composite. Opening 351 can be temporarily stretched wider to admit shaft 303; then the stiffness and tension of the material return opening 351 as close to its original narrow width as the bulk of shaft 303 allows, so that shaft-mounting clip 305 tightly grips shaft 303. Optionally, the inside surface 352 of clip 305 may be lined or coated with a non-slip material to anchor the transmitter assembly in place. Alternatively, the flexible-band-based couplings described in conjunction with the embodiment of FIG. 1 may be used here as well.

In some situations, watercraft and their MMPIs are regularly transported overland without much protection (e.g. thrown in a wagon or truck bed). The configuration of FIGS. 3A, 3B with the removable clip or strap is one solution; the actuator/transmitter assemblies can be taken off the MMPI shafts, transported in a separate container such as a tackle box or backpack, and then popped back on at the beach or boat-launch. Another alternative is the “built-in” approach. MMPIs used in water that is reasonably smooth (such as a lake, harbor, or deep river) can last a long time but electronics attached to the outsides of them can be vulnerable. For these applications, all components of the trigger unit and transmitter except the actuator(s) are sealed and, if necessary, cushioned in cavities fabricated inside the MMPI grip or shaft. The cavities may be sealed by, among other options, screw-on or snap-on cover(s) incorporating perimeter O-rings or other elastomeric gaskets. The MMPI with built-in electronics can be a single piece, or the modified grip or shaft section can be detached from the remainder of the shaft and the blade, if any, and attached to the shaft and blade of a different MMPI. Alternative paddle grip may be integrally manufactured with the watercraft paddle shaft, or alternative paddle grip may incorporate a threaded protrusion for threading into a threaded insert in an open end of paddle shaft.

FIG. 4 illustrates a preferred embodiment for a paddle or pole with a forked or T-shaped grip. An actuator 402 is positioned on end of each arm of grip 404. The two actuators are redundant to each other. No matter which hand is on grip 404 or which way the paddle blade (not shown) is oriented, one or the other actuator 402 is easily reached by the operator without interrupting the maneuvering of the watercraft. Also, this figure illustrates “purpose-built” embodiments where all the electrical hardware from the actuator to the transmitter is routed inside grip 404 or shaft 405 for maximum protection from mechanical damage. In another embodiment, curved triggers similar to pistol triggers with or without trigger guards are installed on the arms of the grip as actuators, in such orientations that the triggers can be operated with either hand grasping the paddle grip. Hence, if the user switches the paddle from port to starboard or vice versa without rotating the paddle blade, and switches “shaft hand” and “grip hand” accordingly, actuators as described above are still convenient to reach and easy to use.

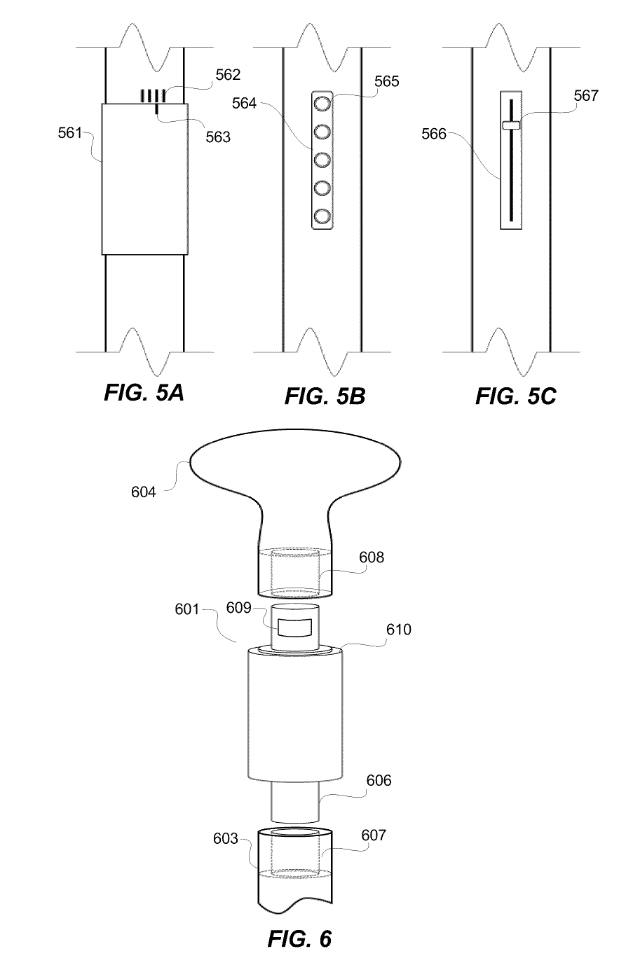

FIGS. 5A, 5B, and 5C are examples of paddle shafts, oar handles, or pole sections with built-in multi-position selector switches as actuators. These multi-position actuators may be used besides, or instead of, on/off switches, depending on the nature of the target device. For example, the positions may correspond to variations in speed of a motor, brightness of a spotlight, or volume of a speaker. These controls may be located on or near an oar handle, near a paddle grip, in the middle of the shaft of a double-ended paddle such as a kayak paddle, or between the center and top end of a pole.

In FIG. 5A, rotatable selector 561 incorporates a selection indicator 562 which may be aligned with any of markers 563 by hand-rotating rotatable selector 561 around the shaft of the MMPI. Rotatable selector 561 is preferably a ring or cylindrical shell of plastic, hard rubber, or other electrically insulating, moisture-insensitive material. Internal electrical contacts (not visible) complete one of several distinct electrical circuits depending on which set marker 563 is aligned with selection indicator 562. Depending on which circuit is completed, the built-in wireless transmitter (not shown in this view) sends a different command to the corresponding wireless receiver (also not shown in this view). Internal mechanical detents (not shown) may correspond with markers 563, making an audible or touch-sensible “click” as indicator 563 becomes aligned with a marker. This can obviate the need for the operator to look at selector 561 while operating it.

FIG. 5B illustrates a selector comprising a built-in array 564 of buttons 565. Each button can manipulate internal electrical contacts to complete a circuit as with the rotatable selector of FIG. 5A. When multiple receivers or variables need to be controlled, button array 564 can be advantageously coupled with a microprocessor-controlled transmitter so that double-taps and multiple buttons pressed simultaneously can be recognized and result in different transmitter signals.

FIG. 5C illustrates a built-in slider control for applications where continuous or quasi-continuous control of a target-device variable is desired. The position of slider 567 in slot 566 varies a resistance, capacitance, or inductance in a circuit within the trigger unit (not visible in this view). The transmitter signal depends on the trigger-unit output. Alternatively, a similar design could be used for control in discrete steps by distributing markers or detents along the length of slot 566.

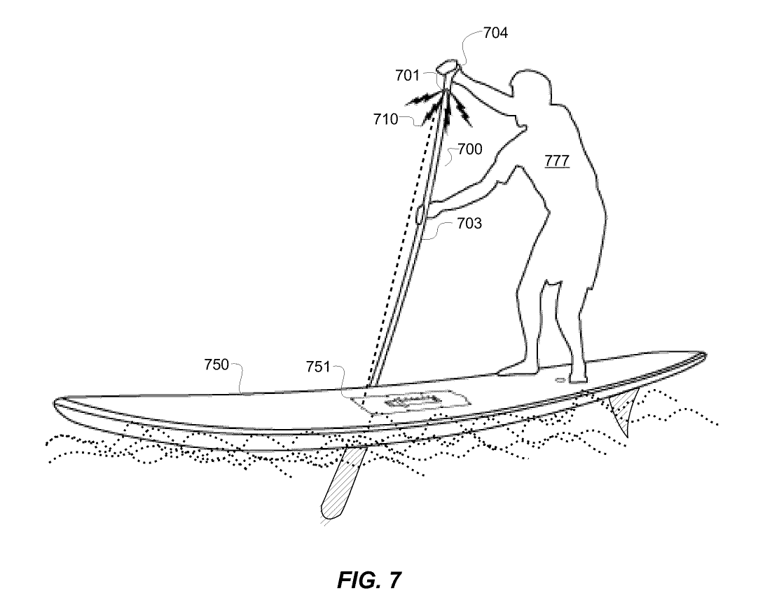

FIG. 6 illustrates a removable shaft section that protects the electronics as in a built-in embodiment, yet is made to be interchangeable between different compatible MMPIs. Actuator(s) (illustrated here as rotatable outer cylinder 610) are accessible from the outside of, and other trigger-unit and transmitter electronics are sealed inside of, housing 601. Housing 601 is slightly larger in maximum diameter than shaft 603 for convenient location by touch. A removable seal 609 allows access to the power source (e.g., battery) for recharging or, if needed, replacement. Another approach to recharging the transmitter's power source is to position small, lightweight solar cells on parts of the MMPI likely to receive sunlight, such as the shaft surface or the blade surfaces. The strength of the removable shaft section is provided by central axle tube 606, designed to be similar in strength and rigidity to the rest of MMPI shaft 603. The ends of axle tube 606 mate in any suitable way (threads, bayonet-type latch, snap-in features, set screws, or the like) with recesses 607, 608 in shaft 603 and grip 604. For some MMPIs, such as kayak paddles, long poles, or two-handed sweeps, another shaft 603 would take the place of grip 604; for sculls and single-handed oars, the interchangeable section may itself be the end of the handle.

When an operator rotates outer cylinder 610 to various positions, the characteristics of a trigger-unit circuit (for example, contact between conductive areas on the inside of cylinder 610 and the outside of axle tube 606) change, resulting in corresponding changes in the transmitter signal. When not desiring to engage whatever function the receiver controls, the operator user may grip an adjacent part of shaft 603 rather than outer cylinder 610. On a single-bladed, two-handed paddle, as on canoes and SUP surfboards, a rotatable actuator like outer cylinder 610 may be more conveniently operated with the “shaft hand” than the “grip hand,” and in those cases may be installed further down shaft 603 than immediately adjacent to end grip 604.

With this type of actuator, the transmitter controller may be set up so that rotating outer cylinder 610 continuously in one direction causes the transmitter to send signals interpreted by a receiver controlling a propulsion motor to first activate, then continuously increase the power delivered to the motor. Conversely, rotating outer cylinder 610 continuously in the opposite direction causes the transmitter to signal the receiver to command the controller to first decrease power level, and then finally deactivate the motor. Additionally, outer cylinder 610 may be spring-loaded so that it returns to the “off” position unless actively prevented from doing so. If the operator must continuously apply torque to outer cylinder 610 to maintain motorized propulsion, the motor will safely shut down if, for example, the operator accidentally drops the paddle.

Alternatively, outer cylinder 610 may have a series of internal detents to create “click-stop” positions for specific functions, such as “off”, low, medium, high, and reverse speed settings for a propulsion system. With this type of design, the operator may maintain propulsion at constant power, similar to an automobile's “cruise control” function, without continuing to rotate outer cylinder 610.

FIG. 7 illustrates an application example in stand-up paddle (SUP) surfing on a board with a propulsion motor controlled via a wireless receiver (such as the battery-powered electric jet-pump propelled surfboard previously disclosed by Applicant in international application #PCT/US11/24700). Paddle-integrated wireless controller 701, with a transmitter signal 710 keyed to a receiver on propulsion unit 751, is built into or mounted on paddle 700. In the water, operator 777 stands on board 750 and holds paddle 700 with one hand on grip 704 and the other on shaft 703, just as in normal paddling of an unmotorized SUP board. When a propulsion assist is desired (for instance, to escape an eddy or adverse current, evade an obstacle, or catch an incoming wave), operator 777 engages an actuator for controller 701, producing a “motor on” transmitter signal 715 that activates propulsion unit 751. If operator 777 ceases to need a propulsion assist, as after attaining desired dynamic equilibrium on a moving wave face, propulsion unit 751 may be deactivated using the actuator for controller 701. A motorized SUP surfboard may also be used in “flat” water such as lakes, ponds, rivers, and even swimming pools, where operators may learn and practice basic skills or simply enjoy the ride. A wireless controller for the motor that does not interfere with paddling or steering enhances learning progress and enjoyment.

Only the claims appended here (along with those of parent, child, or divisional patents, if any) define the limits of the protected intellectual-property rights. The written description above and the accompanying drawings provide illustrative examples of how an authorized person may practice the invention without undue experimentation, including the best mode known to the inventors at the time of filing. The claims may encompass other embodiments, variations, and equivalents that are implicit in, or may be extrapolated from, the foregoing description; all of these must be considered to be protected under the applicable law.

We claim:

1. A wireless control system for a target device associated with a watercraft, comprising:
an implement configured to manually propel or steer the watercraft,
a wireless transmitter mounted on the implement,
an actuator mounted on the implement and connected to control the wireless transmitter, and
a wireless receiver configured to control the target device in response to signals from the wireless transmitter.

2. The system of claim 1, where the implement is selected from the group of paddles, oars, poles, sculls, and sweeps.

3. The system of claim 1, further comprising a power source connected to the wireless transmitter.

4. The system of claim 3, where the power source is rechargeable.

5. The system of claim 4, further comprising a solar cell mounted on the implement and connected to recharge the power source.

6. The system of claim 1, further comprising a transmitter microprocessor with an information-storage element connected to the actuator and the wireless transmitter, and programmed to recognize a variety of manipulations of the actuator and issue a corresponding variety of commands to the wireless transmitter, causing the wireless transmitter to emit a corresponding variety of signals.

7. The system of claim 1, where the transmitter comprises a radio-frequency transmitter.

8. The system of claim 7, where a conductive shaft of the implement is connected to act as an antenna for the wireless transmitter.

9. The system of claim 7, where a linear antenna is routed from the wireless transmitter through a channel in a non-conductive shaft of the implement.

10. The system of claim 1, where the actuator is positioned close to a typical hand position of an operator using the implement.

11. The system of claim 10, where the actuator is designed and positioned for both right-handed and left-handed use.

12. The system of claim 10, further comprising a redundant actuator positioned for use by an opposite hand.

13. The system of claim 10, where the actuator is configured to alter the signals from the wireless transmitter in discrete, quasi-continuous, or continuous increments.

14. The system of claim 10, where the actuator delivers a tactile feedback when changing the signal from the wireless transmitter.

15. The system of claim 10, where the actuator is selected from the group of a spring-loaded button, a curved trigger, a twist-grip, a slider, and a Hall-effect sensor.

16. The system of claim 1, where the actuator, the wireless transmitter, and connections therebetween are capable of attachment and detachment from an implement in the field.

17. The system of claim 16, where the actuator, the wireless transmitter, and connections therebetween are housed in a shaft segment with mechanical coupling features configured to mate with neighboring parts of a shaft portion of the implement.

18. The system of claim 1, where the wireless receiver is keyed to ignore signals other than those of a particular wireless transmitter.

19. The system of claim 1, further comprising a receiver microprocessor with an information-storage element connected to the target device and the wireless receiver, and programmed to recognize a variety of signals reaching the wireless receiver and issue a corresponding variety of commands to the target device, causing the target device to responsively perform a corresponding variety of actions.

20. The system of claim 1, where the target device is configured to safely pause a function in progress if the receiver stops receiving the control signals.

21. The system of claim 20, where
the target device comprises a propulsion motor,
the function in progress comprises delivering power to the propulsion motor, and
the safely pausing comprises a gradual ramp-down of power to prevent a sudden jarring stop.

22. A method of installing a wireless control interface in a manual marine-propulsion implement, comprising:
providing an actuator operable with one hand by an operator holding the implement,
connecting the actuator to a transmitter assembly comprising a wireless transmitter, a trigger unit controlling the wireless transmitter responsively to manipulations of the actuator, and a power source connected to supply power to the wireless transmitter,
mounting the actuator near an expected hand position of an operator using the implement, and
sealing the transmitter assembly into a cavity in the implement, such that water is excluded but signals from the transmitter may propagate outside the implement.

23. The method of claim 22, further comprising hollowing out the cavity in an implement having no pre-existing cavity of a size, shape, and location to accommodate the transmitter assembly.

24. The method of claim 22, further comprising
fabricating a separate segment for the implement, where the separate segment comprises the cavity, and
conjoining the separate segment to a complementary segment to construct the finished implement.

25. The method of claim 24, further comprising detaching a complementary segment in the field and replacing it with a different complementary segment to construct a different finished implement.

26. The method of claim 22, further comprising adjusting the actuator position to accommodate an individual operator's physical characteristics.

27. The method of claim 22, where sealing comprises encapsulating moisture-sensitive portions of the actuator, transmitter, and any connections between them in a waterproof potting compound.

28. A means of controlling a target device associated with a watercraft, comprising:
a means for operator input of commands attached to a means of manually propelling or steering the watercraft, and
a means for wirelessly transmitting the commands to the target device, where
at least the input means and the transmitting means are encapsulated for resistance to moisture, mechanical shock and stress, temperature cycles, chemical exposure, and solar radiation typically experienced by the means of manually propelling or steering.
